(19) United States
(12) Patent Application Publication
(10) Pub. No.: US 2025/0191263 A1
(43) Pub. Date: Jun. 12, 2025

(54) METHOD FOR CONTROLLING INFORMATION PROCESSING APPARATUS, INFORMATION PROCESSING APPARATUS, AND STORAGE MEDIUM

(71) Applicant: CANON KABUSHIKI KAISHA, Tokyo (JP)

(72) Inventor: TAKASHI MIYAUCHI, Tokyo (JP)

(21) Appl. No.: 18/967,480

(22) Filed: Dec. 3, 2024

(30) Foreign Application Priority Data
Dec. 7, 2023 (JP) 2023-207114

(51) Int. Cl. G06T 11/60

(52) U.S. Cl. CPC G06T 11/60

(57) ABSTRACT

The information processing apparatus according to the present disclosure stores a first prompt including an instruction for processing of a first image, the first prompt having been received as an input that is provided to a first trained model which performs processing on and outputs an image. The information processing apparatus further generates a second prompt including at least an instruction for processing of a specified second image, by reusing at least a part of the stored first prompt.

### BACKGROUND

### Field

The present disclosure relates to a method for controlling an information processing apparatus, an information processing apparatus, and a storage medium.

### Description of the Related Art

In layout data editing including layout editing of, for example, a poster and flyer, a template material initially selected is generally as similar to a completion image as possible. After the template selection, texts, images, and other contents are added to or deleted from the selected template, and then the position and size of each content are changed to adjust the overall layout.

In recent years, what is called a generative Artificial Intelligence (AI) technology has been applicable in adding and editing contents in the above-described layout data editing. Examples of such generative AI technologies include Stable Diffusion (registered trademark), ChatGPT (registered trademark), and a generative adversarial network (GAN).

In the layout data editing, image contents included in the template may be edited without changing the layout of the template. In an example case where an event announcement poster for a hot seasonal event is changed to another event announcement poster for a cold seasonal event, if the original poster includes an image of a person wearing summer clothes, the clothes of the person is to be changed to winter clothes appropriate for a cold season. Under such a situation, if the original poster includes images of a plurality of persons, the clothes of all persons are to be changed. Under a situation where common-context-based editing is to be performed for a plurality of image contents like this example, it may be troublesome for a user to issue a prompt instruction as an input to a generative AI for each content.

In view of the above-described situation, various types of techniques have been studied to reduce the user's trouble of issuing a prompt instruction as an input to a generative AI. Japanese Patent No. 7329293 discusses a technique for extracting image information from subject profile information for an image content and from the image content, and automatically generating a prompt to generate an image content based on the information.

Even though, with the technique discussed in Japanese Patent No. 7329293, a new image similar to an original image is generated, it is still difficult to process and edit an existing image in accordance with a user's intention.

### SUMMARY

According to an aspect of the present disclosure, a method that is executed by an information processing apparatus, the method includes storing, in a memory, a first prompt including an instruction for processing of a first image, the first prompt having been received as an input that is provided to a first trained model which performs processing on and outputs an image, and generating a second prompt including at least an instruction for processing of a second image which has been specified, by reusing at least a part of the stored first prompt.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration of an information processing system.

FIG. 2 is a diagram illustrating an example of a hardware configuration of an image output apparatus.

FIG. 3 is a diagram illustrating an example of a hardware configuration of an information processing apparatus.

FIG. 4 is a functional block diagram illustrating an example of a functional configuration of the information processing system.

FIG. 5 is a diagram illustrating an example of layout data.

FIG. 6 is a diagram illustrating an example of a layout data editing screen.

FIG. 7 is a diagram illustrating an overview of a generative Artificial Intelligence (AI) technology.

FIG. 8 is a flowchart illustrating an example of processing of the information processing system.

FIG. 9 is a diagram illustrating an example of the layout data editing screen.

FIG. 10 is a diagram illustrating an example of the layout data editing screen.

FIG. 11 is a diagram illustrating an example of the layout data.

FIG. 12 is a flowchart illustrating an example of processing that is performed by the information processing system.

FIG. 13 is a diagram illustrating an example of the layout data editing screen.

FIG. 14 is a diagram illustrating an example of the layout data editing screen.

FIG. 15 is a functional block diagram illustrating an example of a functional configuration of the information processing system.

FIG. 16 is a flowchart illustrating an example of processing that is performed by the information processing system.

FIG. 17 illustrates an example of prompt generation using a large-scale language model.

FIG. 18 is a flowchart illustrating an example of processing that is performed by the information processing system.

FIG. 19 is a diagram illustrating an example of the layout data.

FIG. 20 is a diagram illustrating an example of the layout data editing screen.

### DESCRIPTION OF THE EMBODIMENTS

Hereinafter, desirable exemplary embodiments of the present disclosure will be described in detail with reference to the accompanying drawings.

In the specification and the drawings, the same reference numerals are given to constituent elements having substantially the same functional configuration, and the redundant descriptions will be omitted.

### <Overview of Generative AI Technology>

To promote understanding features of an information processing system according to an exemplary embodiment of the present disclosure, an overview of a generative Artificial Intelligence (AI) technology will be described below. The generative AI technology is based on a generation model, such as Stable Diffusion, ChatGPT, and Generative Adversarial Network (GAN).

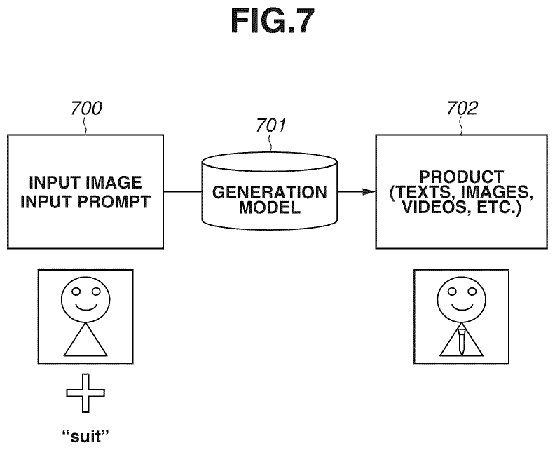

For example, FIG. 7 is a diagram illustrating an overview of a generative AI technology. In the generative AI technology, by using an image and a text as an input image and input prompt 700, a generation model 701 is utilized to output a product 702 including a text, still image, and moving image having strong likelihood of matching with the “context” represented by the input image and input prompt 700. The relationship between an input value and a “context” is acquired through learning using a large number of images and sentences by the generation model 701. In generating the product 702, the generation model 701 changes the initial value generated based mainly on a random number to change the product 702 to be generated.

An example of an information processing system according to a first exemplary embodiment of the present disclosure will be described below.

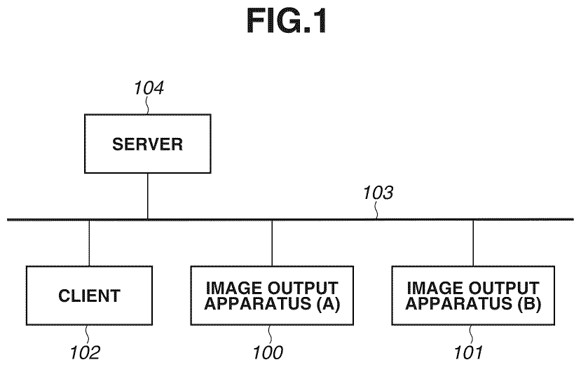

FIG. 1 illustrates an example of a system configuration of the information processing system according to the present exemplary embodiment which is an example of a printing system configured to perform various processes involving layout data editing targeting image output apparatuses. In the printing system illustrated in FIG. 1, the layout data is edited and a print job is transmitted to the image output apparatuses by an externally connected client (for example, a terminal apparatus, such as a personal computer (PC)). Each image output apparatus serves as an apparatus that generates a print product by forming an image on a recording medium such as paper. When a print job is generated, for example, print settings may be edited on the screen of the client. The system configuration of the printing system illustrated in FIG. 1 will be described in more detail below.

As illustrated in FIG. 1, a client 102 is connected to a server 104 and image output apparatuses 100 and 101 via a network 103. The client 102 is used, for example, to edit the layout data, such as a poster and flyer. The client 102 requests the server 104 to perform part of the layout data editing and processing, and rendering processing. The server 104 in FIG. 1 is a schematically illustrated server that performs editing and processing and rendering processing on various data including the layout data. The client 102 applies print settings to the layout data obtained by the editing, to generates a print job, and transmits the print job to a desired image output apparatus (for example, a specified image output apparatus from among the image output apparatuses 100 and 101).

While, in an example case illustrated in FIG. 1, the client 102 accesses two different image output apparatuses via the network 103, the number of image output apparatuses is not limited thereto but may be one or three or more. Likewise, while, in the example case illustrated in FIG. 1, one client and one server are provided, the numbers of the clients and servers are not limited thereto but may be two or more. The network 103 is a desired network, such as a wired Local Area Network (LAN), a wireless LAN, and the Internet.

As an example of print processing, a description will be given of a printing application installed on the client 102 transmits a print job to the image output apparatus 100 via a printer driver. In the present exemplary embodiment, the printing application and the printer driver are pre-installed on the client 102.

The printing application acquires device information on the image output apparatus 100, and print parameters including the paper type, paper size, and print quality, which have been associated with each other, from the printer driver, and edits the print settings within the range of a series of the acquired parameters. The printing application generates a print job based on the above-described print settings and a layout data image obtained by rendering processing by the server 104, and transmits the print job to the image output apparatus 100 via the spooler of the printer driver. The image output apparatus 100 performs printing based on the print settings of the print job received from the printing application.

The image output apparatus 100 stores configuration information about the ink and paper to be used and status information about the idle state and printing errors, as device information. In a case where the image output apparatus 100 is in a state in which printing is not normally performable because of an erroneous status (insufficient remaining amount of paper, running out of ink, etc.) or a print setting failure, the image output apparatus 100 may display a warning message on a panel of its apparatus body to notify the user of the reason why printing is not to be normally performed.

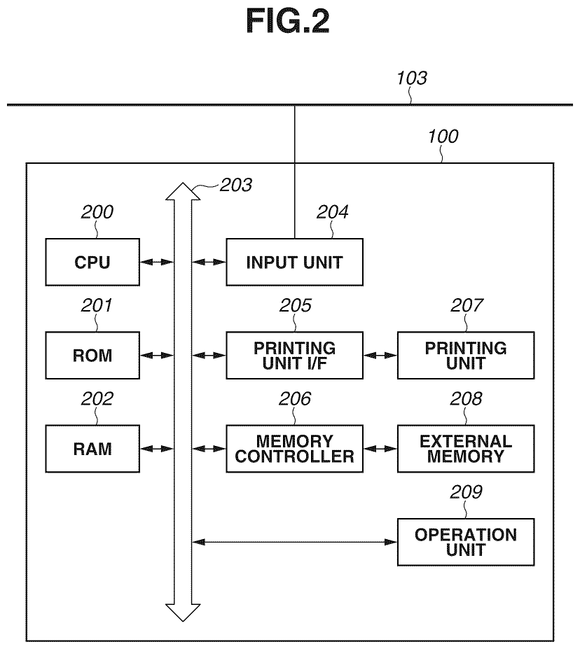

An example of a hardware configuration of the image output apparatus 100 will be described below with reference to FIG. 2. The image output apparatus 101 is implemented with substantially the same configuration as the image output apparatus 100, and the redundant detailed descriptions will be omitted.

The operation of the image output apparatus 100 is controlled by a central processing unit (CPU) 200. The CPU 200 operates based on a control program stored in a program area in a read only memory (ROM) 201 or a control program stored in a storage area, such as an external memory 208. The CPU 200 outputs an image signal as output information to a printing unit (printer engine) 207 connected to a printing unit I/F 205 via a system bus 203. The CPU 200 may communicate with the client 102 via an input unit 204 to notify the client 102 of information about the inside of the image output apparatus 100 via the communication. The CPU 200 also receives output data to be output to the printing unit 207 via the input unit 204.

A Random Access Memory (RAM) 202 is a temporary storage area that functions as the main memory or a work area of the CPU 200. The RAM 202 may be configured to increase the memory capacity by using an optional RAM connected to an extension port (not illustrated). The RAM 202 is used as an output information decompression area, environmental data storage area, and nonvolatile memory.

The external memory 208 is implemented by a hard disk drive (HDD) or an integrated circuit (IC) card, and access to the external memory 208 is controlled by a memory controller 206. The external memory 208 connectable as an option and stores font data, an emulation program, form data, information about the ink used, information about the type and size of feeding paper, and apparatus body status information.

An operation unit 209 including a panel implemented by a display apparatus, such as a liquid crystal display (LCD), is configured to display various information on the panel.

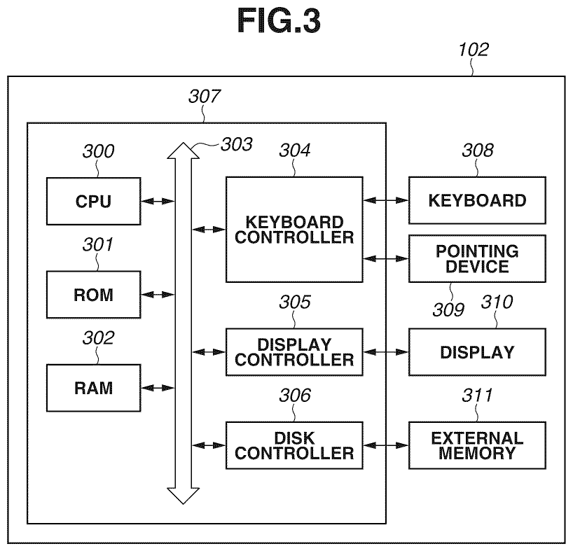

An example of a hardware configuration of an information processing apparatus applicable as the client 102 illustrated in FIG. 1 will be described below with reference to FIG. 3. The server 104 is implemented with substantially the same configuration as the client 102, and the redundant detailed descriptions will be omitted. The server 104 may be a virtual server (what is called a cloud server) implemented by cloud computing.

A main body 307 of a computer includes a CPU 300, a ROM 301, a RAM 302, a keyboard controller 304, a display controller 305, and a disk controller 306.

The CPU 300 reads various programs, such as control programs, system programs, and application programs from an external memory 311 into the RAM 302 via the disk controller 306. The CPU 300 performs various data processing and display control of a display 310 by executing various programs read in the RAM 302. The CPU 300 may read a control program from the ROM 301. The CPU 300 may be implemented as a dedicated circuit, such as an application specific integrated circuit (ASIC). The CPU 300 and dedicated circuit are equivalent to an example of a hardware circuit and hardware processor.

The disk controller 306 performs access control for the external memory 311, such as an HDD, compact disc read only memory (CD-ROM), digital versatile disc read only memory (DVD-ROM), and Universal Serial Bus (USB).

The RAM 302 may be configured to be expanded in capacity by using an optional RAM (not illustrated) and is mainly used as a work area of the CPU 300.

The keyboard controller 304 controls key entry from an input apparatus, such as a keyboard 308 and a pointing device 309.

The display controller 305 performs display control for the display 310.

According to each exemplary embodiment of the present disclosure, unless otherwise specified, the CPU 300 controls various units connected to a main bus 303 via the main bus 303. Optional components, such as the display 310, may be omitted from the server 104.

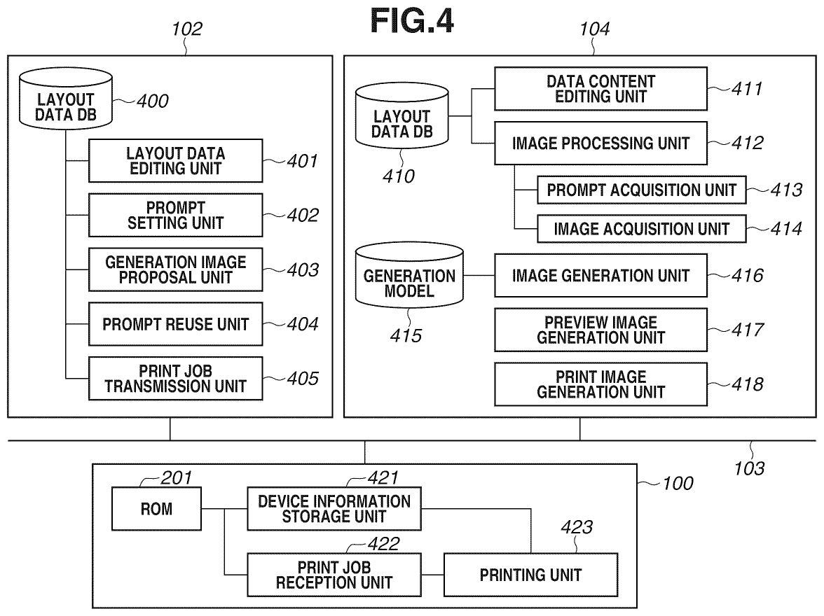

An example of a functional configuration of the information processing system according to the present exemplary embodiment will be described below with reference to FIG. 4. The description will be given by particularly focusing on the configurations of the image output apparatus 100, the client 102, and the server 104 described above with reference to FIGS. 1 to 3. The image output apparatus 101 has substantially the same configuration as the image output apparatus 100, and the redundant detailed descriptions will be omitted.

Examples of functional configurations of the client 102 and server 104 will be described below.

A layout data editing unit 401 adds and deletes content, such as texts and images, and adjusts the layout of each content in a print product, such as a poster and flyer. In processing of color tone correction, clipping, filling, and other processing that are performed on each content, the layout data editing unit 401 requests a data content editing unit 411 of the server 104 to perform the processing. The layout data is stored as a cache in a layout data database (DB) 400 of the client 102 or stored in a layout data DB 410 of the server 104 on a client basis of each client 102 (or for each account in a case where a user account exists).

A prompt setting unit 402 acquires prompt information serving as an instruction for image processing.

A generation image proposal unit 403 requests an image processing unit 412 of the server 104 to perform image processing. The image processing unit 412 of the server 104 receives an instruction from the generation image proposal unit 403 and requests an image generation unit 416 to perform image generation. In this processing, the prompt information acquired by a prompt acquisition unit 413 and an image acquired by an image acquisition unit 414 are used for the request.

The image generation unit 416 generates an image by using a generation model 415. The generation model 415 corresponds to a trained model that has learned through machine learning to process an input image based on an input prompt to generate an output image (image obtained by processing). The generation model 415 also corresponds to an example of a “first model”. The generated image by the processing is transmitted to the client 102 from the image processing unit 412. Then, the generation image proposal unit 403 of the client 102 proposes the above-described image transmitted from the image processing unit 412 to the user.

A print job transmission unit 405 generates a print job and transmits the generated print job to the image output apparatus 100. In generation of a print job, the print job transmission unit 405 requests a preview image generation unit 417 and a print image generation unit 418 of the server 104 to preview the layout data and generate a print image.

An example of a functional configuration of the image output apparatus 100 will be described below.

The ROM 201 has a device information storage unit 421, a print job reception unit 422, and a printing unit 423.

The print job reception unit 422 receives a print job transmitted from the client 102.

The printing unit 423 performs print processing based on the received print job.

The device information storage unit 421 stores information about the type and remaining amount of ink mounted on the image output apparatus 100, information about the type and size of registered and feeding sheet, status information on the apparatus body of the image output apparatus 100, and status information on a print job. In a case where the image output apparatus 100 to be used is determined, the information stored in the device information storage unit 421 may be used to generate layout data appropriate to the image output apparatus 100.

In this case, target information may be acquired from the device information storage unit 421 and stored in the client 102 or the server 104 in association with the layout data DB 400 or 410.

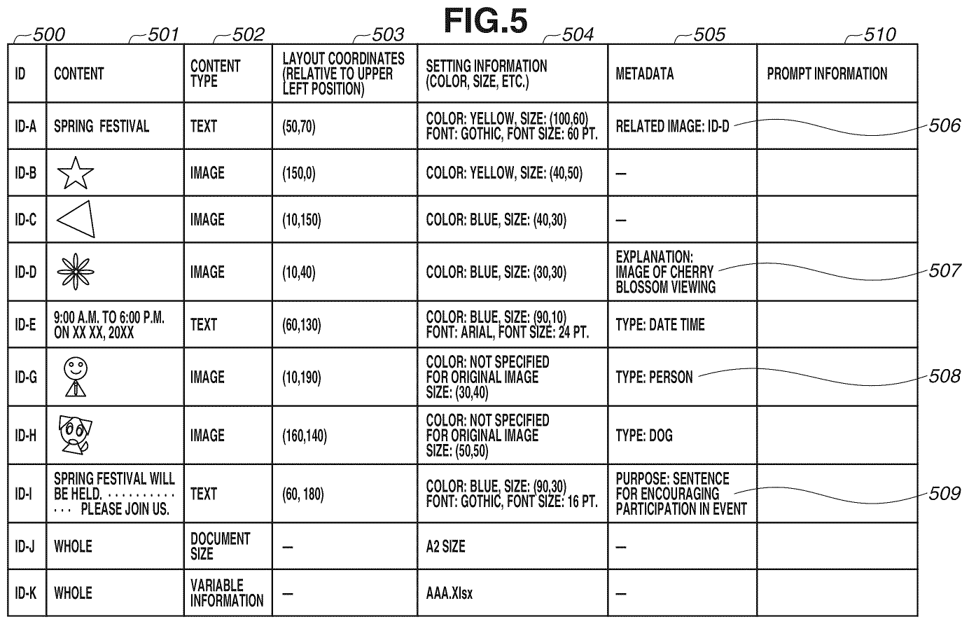

An example of the layout data stored in the layout data DBs 400 and 410 will be described below with reference to FIG. 5. The layout data DB 400 is stored in an external memory or RAM of the client 102, and the layout data DB 410 is stored in an external memory or RAM of the server 104. For example, the data table illustrated in FIG. 5 is stored for each piece of the layout data. The data table illustrated in FIG. 5 includes fields of an identifier (ID) 500, a content 501, a content type 502, layout coordinates 503, setting information 504, and metadata 505. Information about each content is settable in each field.

Identification (ID) information for uniquely identifying the content on the layout data is set in the field of the ID 500.

The value of each content, such as a text and image laid out on the layout data, is set in the field of the content 501.

Information indicating the type of the content set in the fields of the content 501 is set in the field of the content type 502.

The value indicating the position of the content on the layout data is set in the field of the layout coordinates 503.

Attribute values indicating the feature of each content, such as the color and size of the content, are set in the field of the setting information 504.

Settings for the entire layout data, such as the document size and variable printing data, may be stored in the field. In this case, for example, a value “All” is stored in the field of the content 501, the setting type is stored in the field of the content type 502, and setting values may be stored in the field of the setting information 504.

The above descriptions are merely illustrative. For example, a different file may be used on a parameter type basis, or parameters of types other than the above-described types may be included in the layout data.

Metadata of each content can be stored in the field of the metadata 505. According to the present exemplary embodiment, for example, the ID of a related image may be set in the field of the metadata 505, as indicated by a sample 506.

In a case where the content type 502 is image, the explanation of the image may be set in the field of the metadata 505. As a specific example of a sample 507, a text “explanation: image of cherry blossom viewing” is set in the field of the metadata 505. In the example of a sample 508, a text “type: person” is set in the field of the metadata 505 for the target image.

If the content type 502 is text, information about the type and purpose of the target text may be set in the field of the metadata 505. As a specific example of a sample 509, information indicating the purpose of the target text is set in the field of the metadata 505.

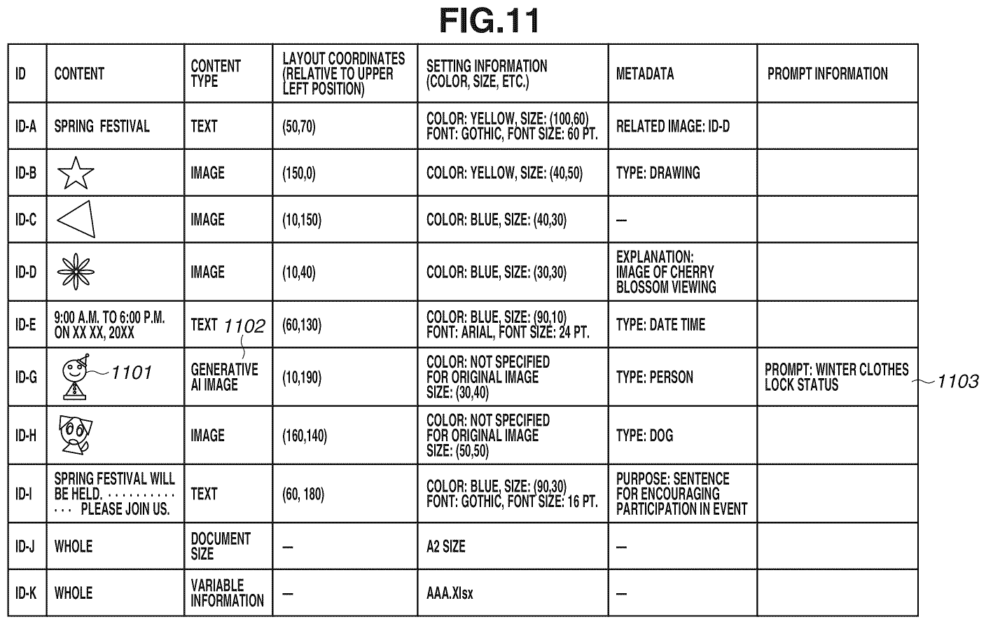

In a case where the target content is edited by using a generative AI (for example, the generation model 415) for editing a content according to an input prompt, the prompt information to be input to the generative AI can be stored in the field of prompt information 510. Details to be stored as the prompt information will be separately described below with reference to FIG. 11.

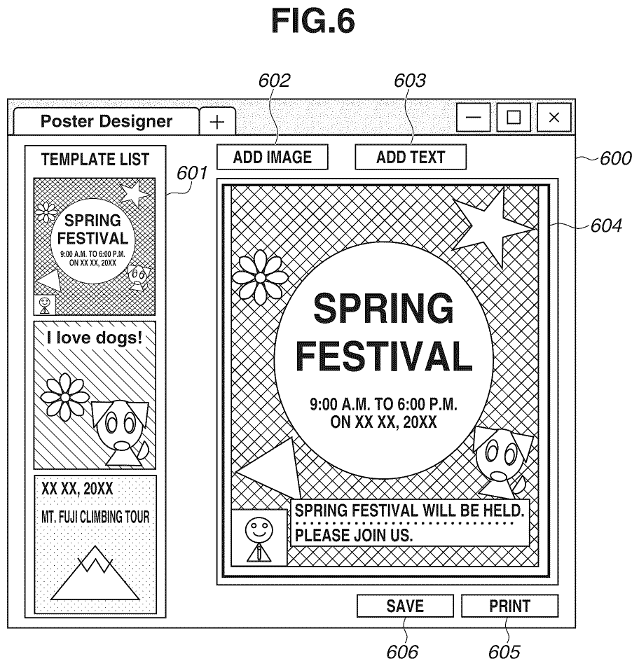

An example of a layout data editing screen 600 for the image output apparatus 100 that is displayed on the display 310 of the client 102 will be described below with reference to FIG. 6. The layout data editing screen 600 includes a template list 601 where candidates of layout templates are displayed in a list form. The user views the templates and selects a template closest to the completion form of the layout data from the template list 601. The template selected from the template list 601 is displayed in a layout editing area 604. For example, information about the templates displayed in the template list 601 may be acquired from the layout data DB 400 or 410 as layout data or from an external network service, such as a cloud service and a social network system (SNS) service.

The layout data editing unit 401 or the data content editing unit 411 performs editing, such as position adjustment, color tone correction, clipping, and filling, on the content displayed on the layout editing area 604. The method for selecting a target content is not particularly limited. A content on the layout editing area 604 may be selected by a mouse operation or tap operation, or an addition target content may be specified when a content is added.

In a case where a content is edited via the layout data editing screen 600, for example, a processing menu appears in response to a target content being specified, and a specification of editing details is received from the user via the processing menu.

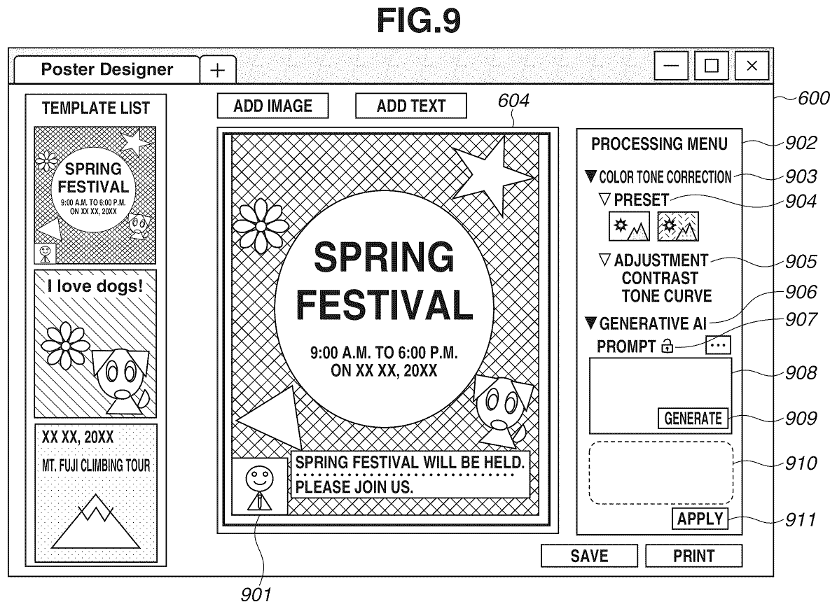

FIG. 9 illustrates an example of a processing menu 902 that is displayed on the layout data editing screen 600. FIG. 9 illustrates an example where the processing menu 902 includes a color tone correction menu 903 and a generative AI processing menu 906 as candidates of menus for specification of processing details.

The color tone correction menu 903 includes, for example, an area 904 via which a specification of the color tone correction from images obtained by processing is received as a preset specification, and an area 905 via which a specification of the color tone correction, such as the contrast and tone curve, is received.

With this configuration, the user specifies details of editing for the color tone correction to be applied to the content displayed on the layout editing area 604 via the areas 904 and 905.

The generative AI processing menu 906 includes a prompt input area 908 via which a specification of the prompt information to be input to the generative AI is received. A lock button 907 is used for a prompt to select whether the prompt information input in the prompt input area 908 is set to be changeable. Enabling the lock state prevents the prompt information from being carelessly changed.

A generation button 909 is used to receive an instruction for generation of an image based on the prompt information input in the prompt input area 908. In response to the generation button 909 being pressed, an image is generated based on the prompt information input in the prompt input area 908 by the generation image proposal unit 403 and then a preview of the image is displayed in a generation image preview area 910.

An apply button 911 is used to receive an instruction for application of the generated image displayed in the generation image preview area 910 from the user. In response to the apply button 911 being pressed in a state where the preview of the generated image is displayed in the generation image preview area 910, the content (image) displayed on the layout editing area 604 is replaced with the generated image. In this processing, the lock button 907 may be locked for the prompt. With this control, in a case where the generated image is determined, the prompt information is prevented from being carelessly changed.

The number of images to be proposed via the generation image preview area 910 by the generation image proposal unit 403 is not limited to one, but a plurality of generation image may be proposed. In a case where a plurality of generated images is proposed via the generation image preview area 910, a generated image to be applied is determined in response to depression of the apply button 911 in a state where the selection of one of the plurality of generated images is received.

While, an example case where menus for the color tone correction function and generative AI processing function are displayed has been described above as an example of the processing menu 902, this example is merely illustrative but does not limit usable processing functions. As a specific example, processing functions including resizing, clipping, filling, and image filtering may be usable. Menus corresponding to these processing functions may be displayed in the processing menu 902.

Although FIG. 9 illustrates an example of the processing menu 902 in a case where the type of the target content is image, processing menus displayed according to the content type may be selectively changed.

An example illustrated in FIG. 6 will be described again below.

An add image button 602 is used to receive an instruction for addition of an image content to the layout editing area 604 from the user. As a specific example, in response to depression of the add image button 602, a dialog on which the file path of the target image content is specified appears. In response to the file path being specified via the dialog, import processing for the file may be performed.

An add text button 603 is used to receive an instruction for addition of a text content from the user. As a specific example, in response to depression of the add text button 603, processing for inserting a new text content may be performed.

The above description is merely illustrative, and does not limit the type of the target content thereto. A button to be used to receive an instruction for addition of the content according to the type of the target content may be displayed. According to the type of the target content, an interface to specify an import source of the content may be provided. An external cloud service storage or an SNS service may be specified as the import source. With a drag-and-drop operation on a content on the layout editing area 604, an instruction for addition of the content may be received.

A print button 605 is used to receive an instruction for execution of printing from the user. In response to the print button 605 being pressed, the print job transmission unit 405 generates a print job of the layout data of which image is displayed on the layout editing area 604, and transmits the print job to the target image output apparatus (for example, the image output apparatus 100 or 101).

A save button 606 is used to receive an instruction for storing of the layout data currently being edited from the user. In response to the save button 606 being pressed, the layout data of which image is displayed on the layout editing area 604 is stored in a predetermined storage area (for example, the layout data DB 400 or 410).

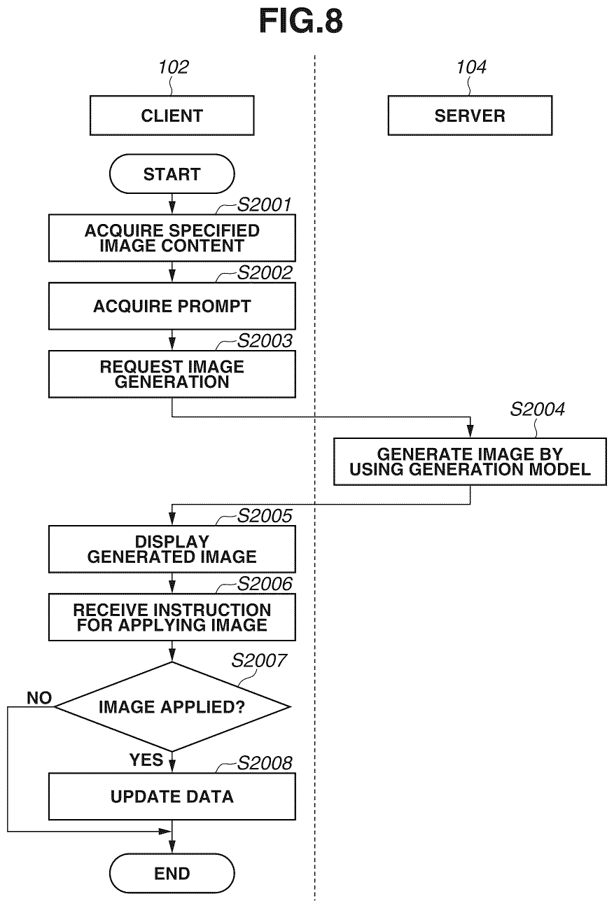

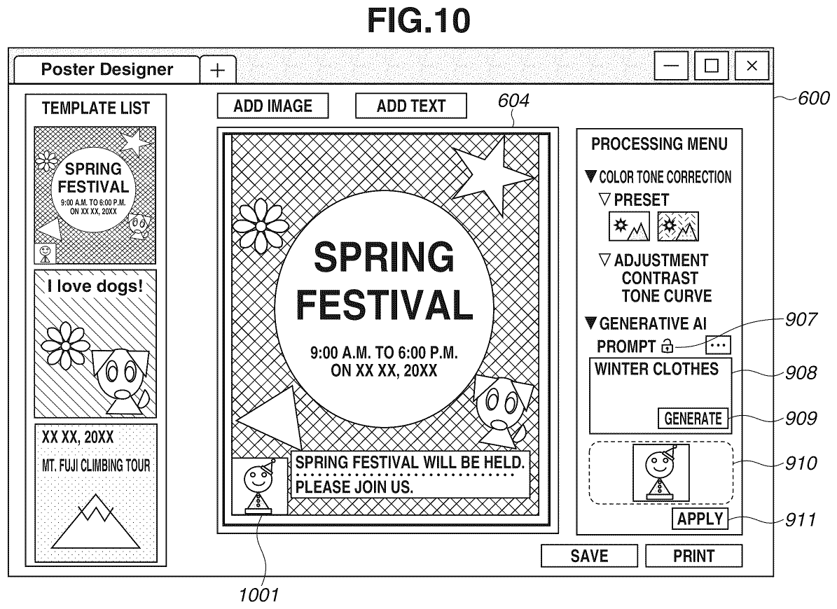

An example of processing of the information processing system according to the present exemplary embodiment will be described below with reference to FIGS. 8 and 10. The description will be given particularly focusing on the processing of the client 102 and the server 104 in a case where the image processing is performed using a generative AI by operations via the layout data editing screen 600. FIG. 8 is a flowchart illustrating an example of processing of the client 102 and the server 104. FIG. 10 illustrates an example of the layout data editing screen 600. In each of the client 102 and the server 104, the series of processing illustrated in FIG. 8 is implemented, for example, by the CPU 300 reading a program stored in the ROM 301 into the RAM 302 and then executing the program.

For example, the series of processing illustrated in FIG. 8 is started by the generation image proposal unit 403, for example, at the timing when the generation button 909 on the layout data editing screen 600 is pressed on the client 102.

In step S2001, the generation image proposal unit 403 acquires the image content specified on the layout editing area 604.

In step S2002, the prompt setting unit 402 acquires the prompt information input in the prompt input area 908.

In step S2003, the generation image proposal unit 403 requests the image processing unit 412 of the server 104 to generate a new image using the prompt information acquired in step S2002.

In step S2004, the image processing unit 412 generates a new image based on the generative AI technology using the generation model 415, via the image generation unit 416. Then, the image processing unit 412 transmits the generated image to the generation image proposal unit 403 of the client 102.

In step S2005, the generation image proposal unit 403 receives the generated image transmitted from the server 104 in step S2004, and displays the generated image in the generation image preview area 910 of the layout data editing screen 600.

In step S2006, the generation image proposal unit 403 receives from the user the instruction for application of the generated image via the apply button 911 on the layout data editing screen 600.

In step S2007, the generation image proposal unit 403 determines whether the instruction for application of the generated image is received from the user (i.e., whether the apply button 911 is pressed by the user).

In a case where the generation image proposal unit 403 determines that the instruction for application of the generated image is not received from the user (NO in step S2007), the generation image proposal unit 403 terminates the series of processing illustrated in FIG. 8.

On the other hand, in a case where the generation image proposal unit 403 determines that the instruction for application of the generated image is received from the user (YES in step S2007), the processing proceeds to step S2008.

In step S2008, the generation image proposal unit 403 updates the data stored in at least one of the layout data DBs 400 and 410, based on the generated image received from the server 104 in step S2005. As indicated by a content 1001 in FIG. 10, the generation image proposal unit 403 replaces the image content on the layout editing area 604 with the above-described generated image. After the image replacement, the generation image proposal unit 403 terminates the series of processing illustrated in FIG. 8.

With application of the control described above with reference to FIGS. 8 and 10, a prompt instruction is received from the user, and then the generative AI is instructed to process and generate an image content by using the prompt as an input.

An example of layout data will be described below with reference to FIG. 11. The description will be given focusing on a case where the image content is updated with the generative AI after the layout data DB illustrated in FIG. 5 is subjected to the processing illustrated in FIG. 8. As indicated by a sample 1101, the target content is updated by the content described above with reference to FIG. 10, i.e., the image generated by the generative AI. As indicated by a sample 1102, the content type of the target content is updated to “Generative AI Image”. In addition, as indicated by a sample 1103, the prompt input in the prompt input area 908 and the status of the lock button 907 for the prompt are added as the prompt information.

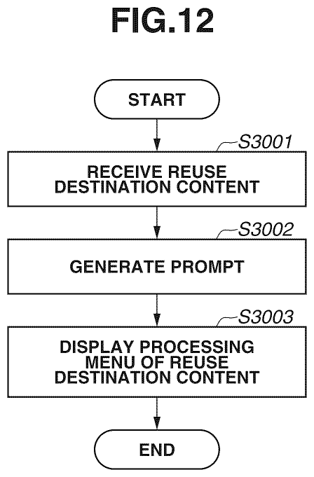

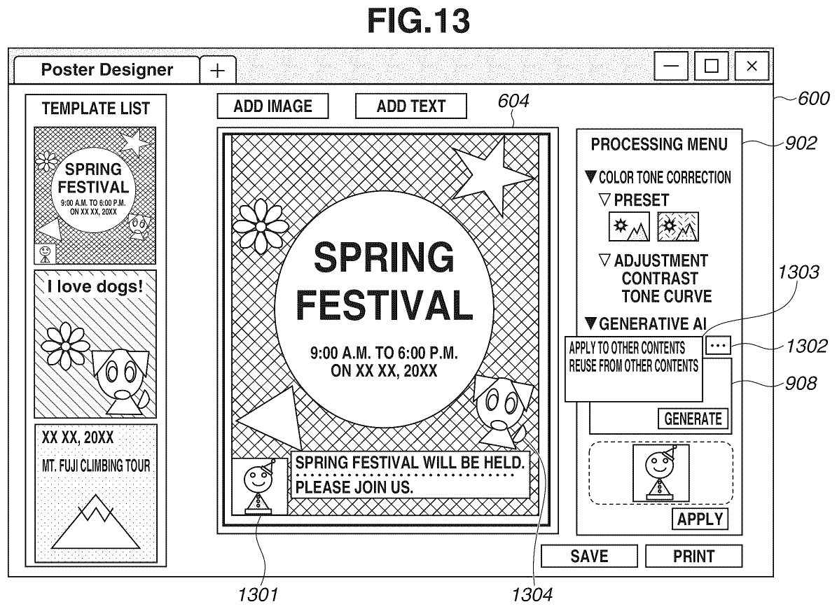

An example of processing of the information processing system according to the present exemplary embodiment will be described below with reference to FIGS. 12 and 13. The description will be given particularly focusing on the processing in a case where the prompt information having been applied to a certain content is reused to processing of other content, according to an instruction through the layout data editing screen 600. FIG. 12 is a flowchart illustrating an example of processing of the client 102. FIG. 13 illustrates an example of the layout data editing screen 600. For example, in the client 102, the series of processing illustrated in FIG. 12 is implemented by the CPU 300 reading a program stored in the ROM 301 into the RAM 302 and then executing the program.

For example, the series of processing illustrated in FIG. 12 is started by a prompt reuse unit 404 at the timing when an instruction for reusing the prompt information is received through the layout data editing screen 600.

FIG. 13 illustrates an example state of the layout data editing screen 600 when the instruction for reusing the prompt information is received. In response to a specification of an image content 1301 generated by the generative AI on the layout editing area 604, the processing menu 902 appears. In this processing, the prompt information having been applied in generation of the image content 1301 is input to the prompt input area 908. In this state, in response to pressing performed on an action button 1302, an action menu 1303 for the prompt is displayed.

In the example illustrated in FIG. 13, the action menu 1303 displays “apply to other content” and “reuse from other content” menus. The “apply to other content” menu corresponds to a menu for reuse of the displayed prompt in performing processing on or of other image content. The “reuse from other content” menu corresponds to a menu for reusing a prompt having been applied in processing from the image content having been processed with the generative AI. The present exemplary embodiment will be described below centering on a case where the “apply to other content” menu is selected upon reception of the instruction for reusing the prompt information in the example illustrated in FIG. 13.

The above description is merely illustrative and does not limit the method for receiving the instruction to reuse the prompt information. For example, instead of the action menu 1303, a UI such as a tool chip may be used to receive the instruction for reuse of the prompt information.

In step S3001, the prompt reuse unit 404 receives a specification of the target content on the layout editing area 604 by a user, wherein the specified target content is a content to which a prompt generated based on the reused source prompt will be applied. In this processing, the prompt reuse unit 404 may refer to at least one of the layout data DBs 400 and 410 to determine whether each content is appropriate as the target content in advance, and then narrow down content to selectable content on the layout editing area 604.

For example, the prompt reuse unit 404 may narrow down content to selectable content having the image content attribute, image content having the unlocked prompt state in the prompt information, and generative AI image content.

As another example, the prompt reuse unit 404 may narrow down content to selectable content based on the type of the source content and the type of the target content stored in the metadata 505, wherein the source content is a content to which the reused prompt has been applied in past and is stored in association with the reused prompt. As a specific example, in a case where an instruction for clothes such as “wear clothes” is issued as a prompt, it may be appropriate to apply the instruction to an image of the person or animal type. Meanwhile, it may be inappropriate to apply the instruction to an image of the drawing type having a figure of, such as round, square, and star. Taking such a situation into consideration, for example, the prompt reuse unit 404 may determine whether the content is of the same type, whether the content is a synonym of a different type, or whether the content belongs to the same category. For example, the determination whether the content is a synonym and whether the content belongs to the same category can be implemented by using the distance which is obtained by conversion of a predefined dictionary or language to a vector.

The prompt reuse unit 404 may narrow down content to selectable content by factoring in the details of the prompt itself. As a specific example, the prompt reuse unit 404 may convert the prompt and the type of the target content into vectors, and then obtain the probability that the content appears in the same context to determine whether the application of the prompt is appropriate.

In response to receipt of a specification of the target content, the prompt reuse unit 404 may determine whether the specified content is appropriate as the target content, and then display a warning according to the determination result.

Determination of whether the specified content is appropriate as the target content in this way prevents a situation where appropriate processing is not performed (for example, intended processing is not performed) with the generative AI when the prompt is reused.

In step S3002, the prompt reuse unit 404 acquires the reuse source prompt (for example, the reuse source prompt was applied to the source content in past) and generates a prompt to be applied to the target content (hereinafter also referred to as a reuse destination prompt) based on the acquired reuse source prompt. In this processing, the prompt reuse unit 404 may generate a reuse destination prompt, for example, by copying the reuse source prompt. As another example, the prompt reuse unit 404 may generate a reuse destination prompt by adjusting the reuse source prompt so that the target content is appropriately processed.

According to the present exemplary embodiment, for convenience, the prompt reuse unit 404 generates a reuse destination prompt by copying the reuse source prompt.

The reuse source prompt corresponds to an example of a first prompt, and the reuse destination prompt generated from the reuse source prompt corresponds to an example of a second prompt. The source content which has been processed with the reuse source prompt (first prompt) corresponds to an example of a first image, and the target content to be processed with the reuse destination prompt (second prompt) corresponds to an example of a second image.

In step S3003, the prompt reuse unit 404 performs control to display the processing menu 902 of the target content in a state where the prompt generated in step S3002 is input to the prompt input area 908. Then, the prompt reuse unit 404 completes the series of processing illustrated in FIG. 12.

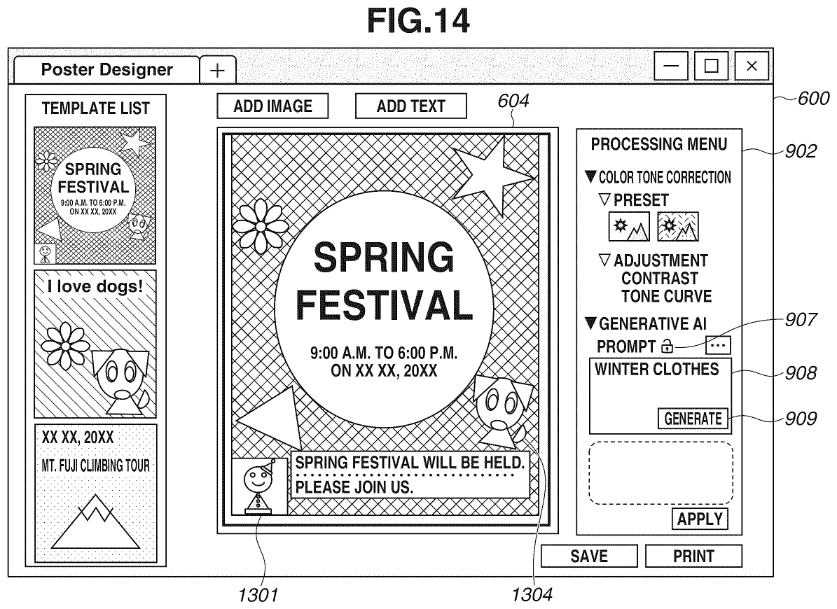

An example of a state of the layout data editing screen 600 will be described below with reference to FIG. 14. The description will be given focusing on a case where a result of the prompt reuse through the processing in FIG. 12 is displayed. In the example illustrated in FIG. 14, the image content 1301 is specified on the layout editing area 604 as the source content which is stored in association with the reused prompt, and an image content 1304 is specified on the layout editing area 604 as the target content to which a prompt generated based on the reused source prompt will be applied. In this case, the processing menu 902 is displayed with the generated prompt input in the prompt input area 908. In response to depression of the generation button 909, the series of processing described above with reference to FIG. 8 is performed, and then the image content 1304 specified as a reuse destination content is subjected to image processing with the generative AI.

With the application of the above-described control, the user easily generates an image content having a similar taste by applying a prompt having been used for a certain content to other content in a similar way, for example, by changing clothes to winter clothes.

Additional prompt editing by the user may be permitted by displaying the lock button 907 of the prompt in an unlocked state. With this control, even in a case where the image content generated by reuse of the prompt in original form is not the one intended by the user, the user corrects the prompt and then easily makes an attempt to regenerate an image content.

While, the present exemplary embodiment has been described above centering on an example case where a specification of one image content is received as the content of the prompt reuse destination, a specification of a plurality of image content may be received. In such a case, information about the reuse source prompt is written to the prompt information 510 for each specified image content in at least one of the layout data DBs 400 and 410.

Instead of completing processing when a result of the prompt reuse is displayed, up to processing related to the image processing using the reused prompt (up to the processing described above with reference to FIG. 8) may be performed as the series of processing. With the application of the above-described control, the user immediately checks the result of processing performed on the reuse destination image displayed on the generation image preview area 910.

As described above, with the information processing system according to the present exemplary embodiment, reuse of a prompt having been used for content processing with the generative AI to process other content. Therefore, even under a situation where a plurality of content is to be edited, without user's complicated operations such as separately inputting a prompt to each content, it is possible for the user to instruct the generative AI to process each content.

More specifically, according to the present exemplary embodiment, user's trouble is reduced in operation related to a prompt instruction to process a plurality of images by using a model configured through machine learning.

An example of an information processing system according to a second exemplary embodiment of the present disclosure will be described below. In the first exemplary embodiment, the description has been given of an example case where the prompt for the image processing is copied and reused in the processing in step S3002 illustrated in FIG. 12. In the present exemplary embodiment, description will be given centering on examples of configuration and processing for generating a prompt so that the reuse destination content is to be appropriately processed (in a way in which the user's intention is reflected in the processing). The description of the present exemplary embodiment will be given focusing on differences from the first exemplary embodiment, and redundant detailed descriptions of portions substantially the same as those in the first exemplary embodiment will be omitted.

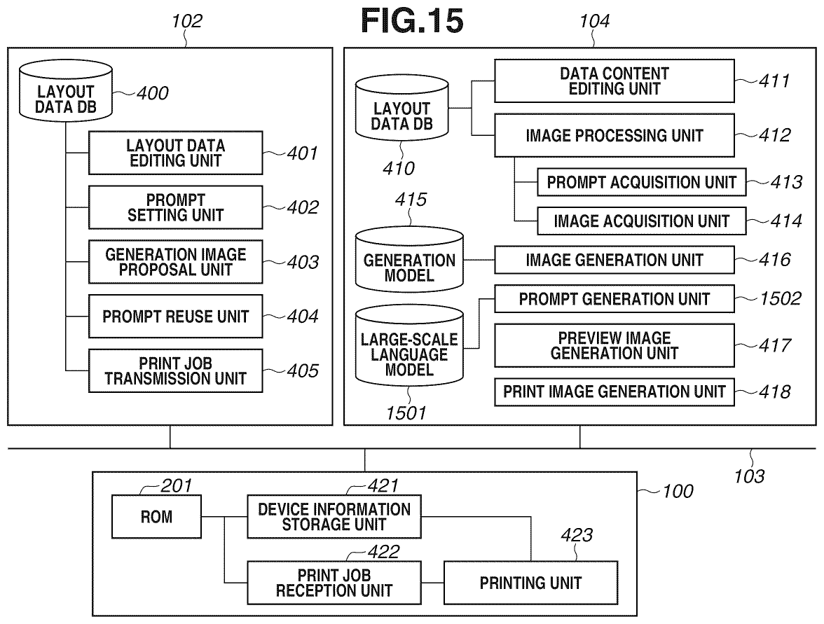

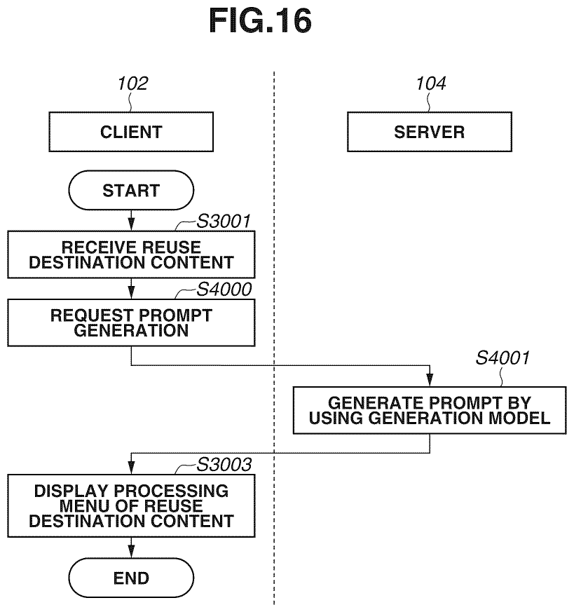

FIG. 15 is a functional block diagram illustrating an example of a functional configuration of the information processing system according to the present exemplary embodiment. As understood from the comparison with the configuration illustrated in FIG. 4, the information processing system according to the present exemplary embodiment is different from that according to the first exemplary embodiment in that a large-scale language model 1501 and a prompt generation unit 1502 are added to the server 104. The large-scale language model 1501 and the prompt generation unit 1502 will be described in detail below, together with the processing of the information processing system, with reference to FIG. 16.

An example of processing of the information processing system according to the present exemplary embodiment will be described below with reference to FIG. 16. The description will be given particularly focusing on the processing of the client 102 and the server 104. The processing in steps S3001 and S3003 is substantially the same as the processing in steps S3001 and S3003, respectively, illustrated in FIG. 12, and the redundant detailed descriptions will be omitted.

In step S4000, the prompt reuse unit 404 requests the prompt generation unit 1502 of the server 104 to generate a prompt.

In step S4001, the prompt generation unit 1502 acquires the image processing prompt of the reuse source via the prompt acquisition unit 413, and generates an image processing prompt according to the target content by using the large-scale language model 1501. The large-scale language model 1501 corresponds to a trained model that has completed learning to generate a prompt based on an input instruction through machine learning, and corresponds to an example of a second model. Then, the prompt generation unit 1502 transmits the generated image processing prompt to the prompt reuse unit 404 of the client 102.

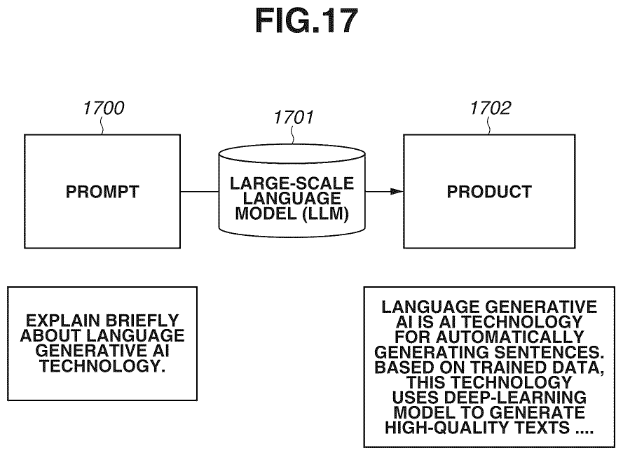

A specific example of the prompt generation using the large-scale language model 1501 will be described below with reference to FIG. 17. In a case where a text generation prompt 1700 representing an instruction related to a generation target text is given, a large-scale language model (LLM) 1701 outputs a product 1702 in a text format highly likely to be applied to the text generation prompt 1700. The relationship between the input value and the “context” has been acquired by the LLM 1701 in learning using a large number of sentences. With a text and an appropriate instruction, the text generation prompt 1700 summarizes the text, expands and translates the content, and performs various processing on the text.

The present exemplary embodiment uses a large-scale language model to generate an image processing prompt. For example, in a case where the source image content includes an image of a person, and the reuse source prompt stored in association with the source image is “wear gloves and boots”, if the target image content includes a dog image, the word “gloves” in the reuse source prompt may be inappropriate. Therefore, the prompt generation unit 1502 may generate a text generation prompt and request the large-scale language model 1501 to generate an image processing prompt matching to the dog image. For example, the text generation prompt in this case has the following content.

Change the image processing prompt “wear gloves and boots” so that the application target of the prompt is appropriate for the dog image.

For example, in response to receipt of an input of the above-described text generation prompt, the large-scale language model 1501 generates an image processing prompt such as “wear boots” and “wear boots on each leg” which are appropriate to the dog image. The generated image processing prompt includes at least a part of the reuse source prompt (e.g. “wear”, “boots”).

With the information processing system according to the present exemplary embodiment, it is possible not only to use an image processing prompt but also to generate a processing prompt appropriate to the reuse destination content.

An example of an information processing system according to a third exemplary embodiment of the present disclosure will be described below. In the first exemplary embodiment, the description has been given centering on an example case where a specification of the source content is received and then a specification of the target content is received. The present exemplary embodiment will be described below centering on an example case where a specification of the target content is received and then a specification of the source content is received. According to the present exemplary embodiment, in the example illustrated in FIG. 13, the image content 1304 is specified on the layout editing area 604, and an instruction for reuse of the prompt is received in response to selection of the “reuse from other content” menu from the action menu 1303.

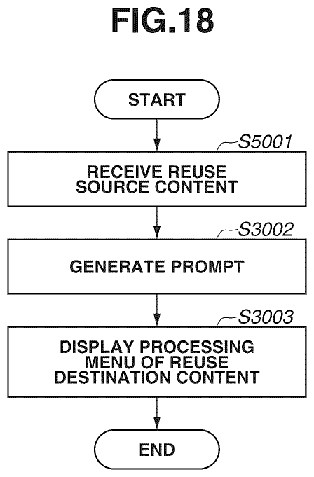

An example of processing of the information processing system according to the present exemplary embodiment will be described below with reference to FIG. 18. The description will be given particularly focusing on the processing of the client 102. The processing in steps S3002 and S3003 is substantially similar to the processing in steps S3002 and S3003, respectively, illustrated in FIG. 12, and the redundant detailed descriptions will be omitted.

For example, the series of processing illustrated in FIG. 18 is started by the prompt reuse unit 404 at the timing when an instruction for reuse of the prompt information is received via the layout data editing screen 600 on the client 102.

In step S5001, the prompt reuse unit 404 receives a specification of the source content on the layout editing area 604. In this processing, the prompt reuse unit 404 may refer to at least one of the layout data DBs 400 and 410 to determine whether each content is appropriate as the reuse destination content in advance, and then narrow down the content to selectable content on the layout editing area 604. As a specific example, it is difficult to reuse a prompt from a content storing no prompt information. Thus, the prompt reuse unit 404 may limit selectable content to content having a prompt information input, as indicated by the sample 1103 in the example illustrated in FIG. 11. The prompt reuse unit 404 may narrow down the content to selectable source content in accordance with the relationship between the types of the source content and the target content and the relationship between the type of the target content and the reuse source prompt.

Application of the above-described control prevents a situation where appropriate processing is not performed (for example, intended processing is not performed) by the generative AI in a case where the prompt is reused.

In response to receipt of a specification of the source content, the prompt reuse unit 404 may present to the user the reuse source prompt which has been applied to the source content in past and the images before and after the processing based on the prompt, as the prompt information.

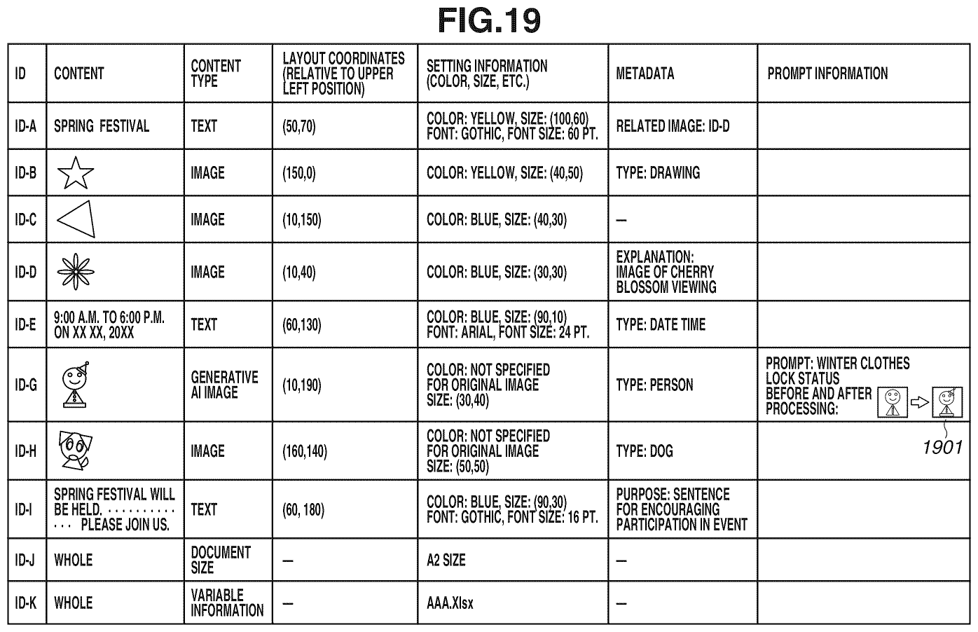

FIG. 19 illustrates an example of layout data according to the present exemplary embodiment. In a case where the image content is processed by the generative AI, the images before and after the processing by the generative AI together with an input of the target prompt may be stored in association with the prompt information, as indicated by a sample 1901.

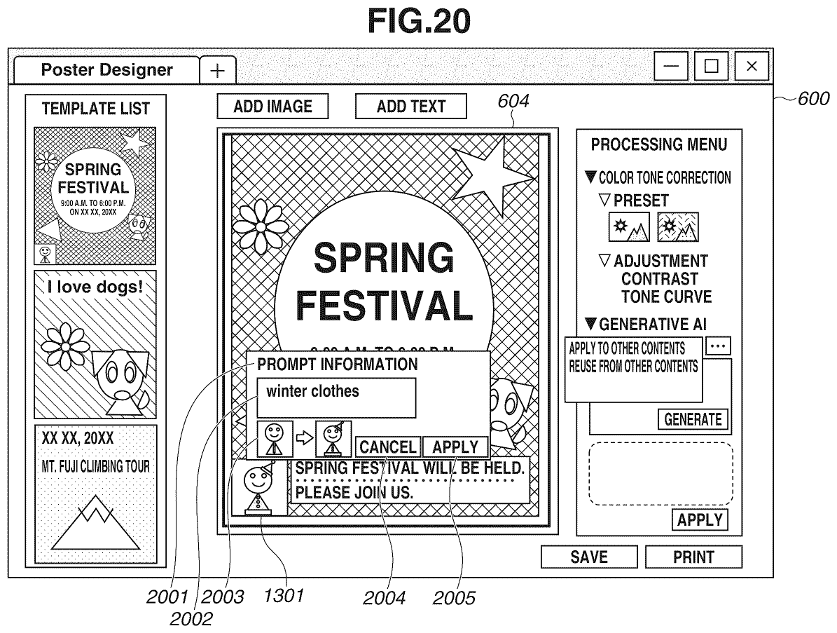

FIG. 20 illustrates an example of a status of the layout data editing screen 600, i.e., an example case where the corresponding prompt information is presented in the prompt reuse. For example, in step S5001 in FIG. 15, the prompt reuse unit 404 may display a prompt information pop-up 2001 in a case where the image content 1301 is specified on the layout editing area 604. The prompt information pop-up 2001 displays a prompt 2002 and a processing image 2003 indicating the images before and after the processing based on the target prompt, according to the prompt information, as indicated by the sample 1901 in FIG. 19.

With the above-described control, the user checks the displayed prompt information and then determines whether to reuse the target prompt. A reuse button 2005 and a cancel button 2004 are used to determine whether the target prompt is reused. More specifically, in response to the reuse button 2005 being pressed, the target prompt is reused. In response to the cancel button 2004 being pressed, the prompt reuse is canceled.

The present exemplary embodiment has been described above centering on an example case where a specification of the target content is received, and then a specification of the source content is received. The images before and after the processing based on the reuse source prompt which has been applied to the source content in past are presented, whereby it is possible for the user to determine whether to reuse the reuse source prompt, before the prompt is actually reused and applied.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While, in the first to third exemplary embodiments, the layout data creation application is used as an example of the application, the application is not limited to this example, and any application having a similar image layout function is usable and the similar advantage is obtainable.

In the first to third exemplary embodiments described above, a personal computer is served as the information processing apparatus. However, the present disclosure is not limited to this example, and can be effectively realized in any information processing apparatus (terminal) which is usable in the same manner, such as a mobile phone, a mobile information terminal, a digital still camera, a digital video camera, a mobile music player, a game, a set-top box, or an Internet home appliance.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-207114, filed Dec. 7, 2023, which is hereby incorporated by reference herein in its entirety.

What is claimed is:

1. A method that is executed by an information processing apparatus, the method comprising:
storing, in a memory, a first prompt including an instruction for processing of a first image, the first prompt having been received as an input that is provided to a first trained model which performs processing on and outputs an image; and
generating a second prompt including at least an instruction for processing of a second image which has been specified, by reusing at least a part of the stored first prompt.

2. The method according to claim 1, further comprising:
receiving an instruction that reuses the first prompt,
wherein, when the instruction for reusing the first prompt is received, the second prompt is generated by reusing at least a part of the first prompt.

3. The method according to claim 2, wherein
the second prompt is generated by reusing at least a part of the first prompt after receipt of a specification of the first image, and when the instruction for reusing the first prompt and a specification of a second image are received.

4. The method according to claim 2, wherein
the second prompt is generated by reusing at least a part of the first prompt after receipt of a specification of the second image, and when a specification of the first image and the instruction for reusing the first prompt are received.

5. The method according to claim 1, wherein the second prompt is generated by reusing at least one of metadata of the first image and metadata of the second image, and the first prompt.

6. The method according to claim 1, wherein the second prompt is generated by inputting the first prompt and an instruction for processing of the first prompt to a second trained model that generates a prompt based on an input instruction.

7. The method according to claim 1, further comprising:
presenting, the first prompt to a user in association with the first image when a specification of the first image is received.

8. The method according to claim 1, further comprising
storing the first prompt, the first image, and the image obtained by the processing in an associated manner in the memory, and
presenting the first image and the image obtained by the processing to a user as images before and after the processing based on the first prompt.

9. An information processing apparatus comprising:
at least one memory that stores instructions; and
at least one processor that executes the instructions to:
storing, in a memory, a first prompt including an instruction for processing of a first image, the first prompt having been received as an input that is provided to a first trained model which performs processing on and outputs an image; and
generating a second prompt including at least an instruction for processing of a second image which has been specified, by reusing at least a part of the stored first prompt.

10. A non-transitory computer-readable storage medium that stores instructions for providing an apparatus, wherein the instructions causes at least one processor of the apparatus to:
store, in a memory, a first prompt including an instruction for processing of a first image, the first prompt having been received as an input that is provided to a first trained model which performs processing on and outputs an image; and
generate a second prompt including at least an instruction for processing of a second image which has been specified, by reusing at least a part of the stored first prompt.
